(19) United States
(12) Patent Application Publication
(10) Pub. No.: US 2022/0291333 A1
(43) Pub. Date: Sep. 15, 2022

(54) INTEGRATED RADAR DEVICE

(71) Applicant: SMART RADAR SYSTEM, INC., Seongnam-si (KR)

(72) Inventors: Yong Hwan KIM, Seoul (KR); Jae Yong LEE, Anyang-si (KR)

(73) Assignee: SMART RADAR SYSTEM, INC., Seongnam-si (KR)

(21) Appl. No.: 17/576,918

(22) Filed: Jan. 15, 2022

(30) Foreign Application Priority Data
Mar. 9, 2021 (KR) 10-2021-0030581

(51) Int. Cl. G01S 7/03; G01S 7/40

(52) U.S. Cl. CPC G01S 7/03; G01S 7/4017

(57) ABSTRACT

According to an integrated radar device of the present invention, a plurality of radar modules are disposed such that radar signals radiated by individual radar modules are directed in different directions, and target detection results according to a local coordinate system output from individual radar modules are transformed to a global coordinate system and then integrated to expand a field of view (FOV).

### CROSS-REFERENCE TO RELATED APPLICATION(S)

This application claims priority from Korean Patent Application No. 10-2021-0030581, filed on Mar. 9, 2021, in the Korean Intellectual Property Office, the disclosure of which is incorporated herein by reference in its entirety.

### BACKGROUND

### 1. Field

The following description relates to radar technology, and more particularly, to a radar device in which signals of a plurality of radar modules are combined to expand a field of view (FOV).

### 2. Description of Related Art

In autonomous driving technology for a vehicle, a key sensor, along with a camera, is a radar sensor. Currently, in radar sensors, radio frequency (RF) circuit parts implemented using conventional non-silicon (Si) semiconductors are replaced with complementary metal-oxide semiconductors (CMOSs), and thus, driving chips implemented at low costs are being commercialized.

Currently, a vehicle radar is provided as a multi-channel radar with three channels including a front long range radar which detects a target within a long distance of about 150 m to 200 m in a forward direction, a front short range radar which detects a target within a short distance of about 60 m in the forward direction, and a rear radar which detects a target a rearward direction and is operated as a multi-channel phase array type which separates RF signals so as to have different phases.

In such a type, a transmitting antenna (Tx Antenna) and a receiving antenna (Rx Antenna) are separated, multiple input-multiple output (MIMO) technology using a phase array is applied so that the same signal is transmitted through antenna arrays oriented in different directions after a phase difference is adjusted so that beams transmitted from different antennas are transmitted without cancelling each other.

Korean Patent Publication No. 10-2017-0025764 (Mar. 8, 2017) discloses a radar module including an optimal arrangement structure of antenna channels for securing a field of view (FOV) and a detection distance such that a vehicle radar including both a long range radar device and a short range radar device simultaneously detects objects disposed at a long distance and a short distance, and a vehicle radar device including the same.

However, there is also a limitation on an FOV that is expandable by differently is designing an arrangement structure of antenna channels.

### RELATED ART DOCUMENTS

### Patent Documents

(Patent Document 0001) Korean Patent Publication No. 10-2017-0025764 (Mar. 8, 2017)

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to a radar device in which a plurality of radar modules are integrated into one device and a field of view (FOV) is expanded using the plurality of radar modules.

In one general aspect, an integrated radar device includes a plurality of radar modules and a control module.

In an additional aspect, the plurality of radar modules may be disposed such that radar signals radiated by the individual radar modules are directed in different directions.

In an additional aspect, the control module may include a coordinate system transformation unit and an integrated tracking unit. The coordinate system transformation unit may receive position outputs of a detected target expressed in a local coordinate system by the individual radar modules and may transform the received position outputs to a global coordinate system, and the integrated tracking unit may is track the target by integrating the position outputs of the individual radar modules transformed to the global coordinate system.

### BRIEF DESCRIPTION OF THE DRAWINGS

FIG. 1 illustrates an integrated radar device in which two radar modules are combined according to the present invention and a concept in which a field of view (FOV) is expanded by the integrated radar device.

FIG. 2 is a block diagram of an integrated radar device according to the present invention.

FIG. 3 illustrates an integrated radar device to which a separate control module is applied according to the present invention.

FIG. 4 illustrates an integrated radar device to which a master radar module including a control module and a slave radar module are applied according to the present invention.

FIG. 5 illustrates a concept of an integrated radar device in which three radar modules are combined according to the present invention.

FIG. 6 schematically illustrates an interface connection between a control module and the radar modules of the integrated radar device of FIG. 5.

FIG. 7 schematically illustrates an example of an integrated radar device to which a frequency modulated continuous wave (FMCW) radar module is applied according to the present invention.

### DETAILED DESCRIPTION

The above-described aspects and other aspects are embodied through embodiments described below with reference to the accompanying drawings. It will be understood that components of each of the embodiments may be combined in various ways within one embodiment unless otherwise stated or contradicted by one another. Each of blocks in a block diagram may be a representation of a physical part in some cases but may be a logical representation of a portion of a function of one physical part or a function of a plurality of physical parts in other cases. In some cases, the block or an entry of a portion of the block may be a set of program instructions. All or some of the blocks may be implemented as hardware, software, or a combination thereof.

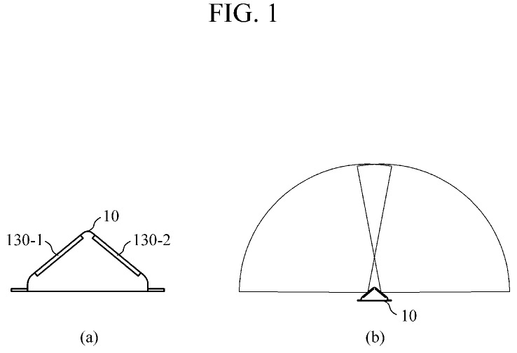

FIG. 1 illustrates an integrated radar device in which two radar modules are combined according to the present invention and a concept in which a field of view (FOV) is expanded by the integrated radar device. Radar modules 130 are provided in one printed circuit board (PCB), and respective radar modules 130-1 and 130-2 provide a predetermined FOV (for example, 120°) in a horizontal direction and a vertical direction, although the FOV may vary according to an antenna arrangement structure. According to the present invention, at least two radar modules 130 may be integrated to expand a provided FOV. As an example, when one radar module 130-1 or 130-2 provides an FOV of 120° in the horizontal direction, as in a shape shown in FIG. 1A, an integrated radar device 10 of the present invention may provide an FOV of 180° or more by integrating two radar modules 130-1 and 130-2 to form a predetermined angle.

When the two radar modules 130-1 and 130-2 are disposed to form a predetermined angle so as to radiate radar signals in different directions as shown in FIG. 1A, an expanded FOV may be provided as shown in FIG. 1B. However, since coordinate systems used to express a target detected by the radar modules 130, that is, local coordinate systems, are different, the coordinate systems should be transformed into a common global coordinate system.

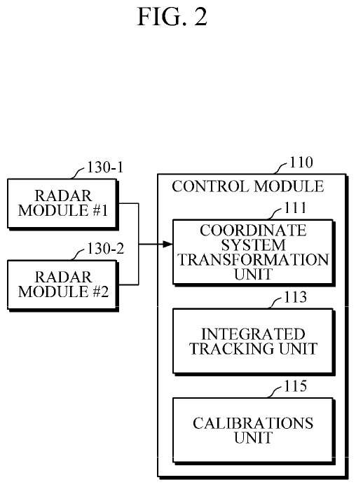

FIG. 2 is a block diagram of an integrated radar device according to the present invention. As shown in FIG. 2, according to one embodiment of the present invention, an integrated radar device 10 includes a plurality of radar modules 130 and a control module 110.

The radar module 130 is a sensor module which transmits an electromagnetic signal, receives an electromagnetic signal returned by being reflected from a target, and estimates a distance to the target and a velocity of the target using a time difference between the two signals and a change in Doppler frequency. The radar module 130 may be a pulse radar type radar module which uses a pulse signal for transmission and reception of a radar or a continuous wave radar type radar module which continuously radiates a transmission signal without a pause time unlike a pulse radar.

The integrated radar device 10 of the present invention includes at least two radar modules 130 as shown in FIG. 1A, and the radar modules 130 are disposed to have a predetermined angle such that radar signals radiated by individual radar modules 130-1 and 130-2 are directed in different directions.

In the integrated radar device 10 of the present invention, a housing of the device may have a polygonal shape according to a range of an FOV to be provided. In the example of FIG. 1, a housing having a triangular shape is used, and the radar modules 130-1 and 130-2 are mounted on two front surfaces to expand an FOV. Unlike the example of FIG. 1, a housing having a triangular shape may be used, and one radar on every surface, that is, three radar modules may be mounted to expand an FOV. As an is another shape, a housing having a quadrangular shape may be used, and one radar on every surface, that is, four radar modules may be mounted to expand an FOV. The number of integrated radar modules may vary according to an FOV, which is to be expanded, and an FOV that can be provided by one radar module 130-1 or 130-2, and in the present invention, the number of the integrated radar modules is not limited, and the housing of the radar device is also not limited to a polygonal shape.

When the plurality of radar modules 130 are arranged to form a predetermined angle, the plurality of radar modules 130 may be disposed such that an FOV area of an individual radar module 130-1 or 130-2 partially overlaps an FOV area of another radar module 130-1 or 130-2. However, the present invention is not limited thereto, and the plurality of radar modules 130-1 and 130-2 may be disposed such that the FOV areas of the individual radar modules 130-1 and 130-2 do not overlap each other according to the purpose of using the integrated radar device 10.

The individual radar module 130 may output an angular position of a target detected from a transmitted radar signal and a reflected and returned signal in a local coordinate system of the corresponding radar module 130.

The individual radar modules 130 may be provided in the form of a PCB or flexible printed circuit board (FPCB) and may have the same antenna arrangement. However, the present invention is not limited thereto, and the individual radar modules 130 may have different antenna arrangements.

The control module 110 includes a coordinate system transformation unit 111 and an integrated tracking unit 113.

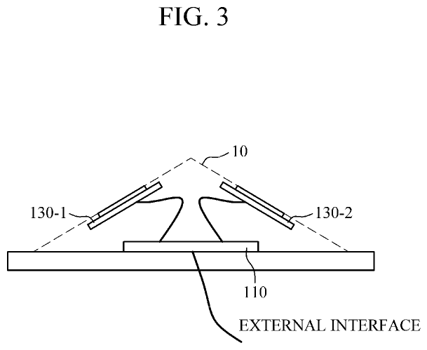

FIG. 3 illustrates an integrated radar device in which a separate control module is applied to a radar device with the shape of FIG. 1A. As shown in FIG. 3, a control is module 110 may include an interface capable of transmitting and receiving data by being connected to individual radar modules 130. The control module 110 may also be provided as a module in the form of independent PCB like the radar modules 130.

A coordinate system transformation unit 111 transforms a local coordinate system of the individual radar module 130 into a global coordinate system to be commonly used in devices. That is, the coordinate system transformation unit 111 receives a position output of a detected target expressed in a local coordinate system by the individual radar module 130 and transforms the received position output to the global coordinate system. In the example of FIG. 1, the coordinate system transformation unit 111 transforms and combines two individual coordinate systems and then integrates the combined coordinate systems into one global coordinate system.

The control module 110 may further include a calibration unit 115 which calibrates the coordinate system transformation unit 111 according to an angle formed between an individual radar module 130-1 or 130-2 and an adjacent radar module 130-1 or 130-2. A coordinate system transformation is more influenced by an arrangement angle between the individual radar module 130-1 or 130-2 and the adjacent radar module 130-1 or 130-2 than an antenna arrangement of the individual radar module 130-1 or 130-2. Before a target is tracked using the integrated radar device 10, the coordinate system transformation unit 111 should be calibrated in advance according to the arrangement angles of the radar modules 130-1 and 130-2.

The integrated tracking unit 113 tracks a target by integrating position outputs of the individual radar modules 130 transformed to the global coordinate system. The integrated tracking unit 113 does not track a target using angular positions of the is detected target output by the individual radar modules 130 but tracks the target in a state in which output results of the individual radar modules 130 are integrated in one global coordinate system.

The control module 110 includes an external interface capable of outputting a target tracking result to the outside.

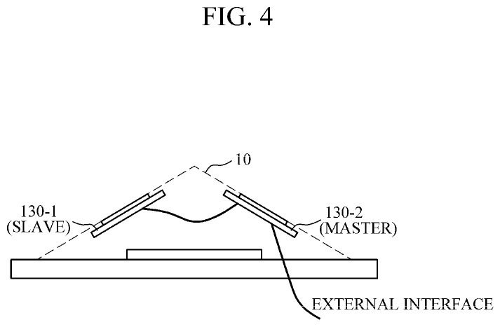

FIG. 4 illustrates an integrated radar device to which a master radar module including a control module and a slave radar module are applied according to the present invention. A control module 110 is included in a PCB of a radar module 130-2 at the right side of FIG. 4. The radar module 130-2 including the control module 110 operates as a master radar module, and the other radar module 130-1 operates as a slave radar module.

According to another embodiment of the present invention, the plurality of radar modules 130-1 and 130-2 may be formed as a master radar module 130-2 and a slave radar module 130-1. The master radar module 130-2 includes the control module 110, and the slave radar module 130-1 is connected directly to the master radar module 130-2 or is connected thereto through another radar module.

In the integrated radar device 10 shown in FIG. 4, since the control module 110 is not provided as an independent PCB module but is included in the PCB of the radar module 130-2, an interface capable of transmitting and receiving data is connected directly between the slave radar module 130-1 and the master radar module 130-2, or one of the slave radar modules 130-1 may be connected directly to the master radar module 130-2, and other slave radar modules may be connected to the master radar module 130-2 through other slave radar modules in a chain type.

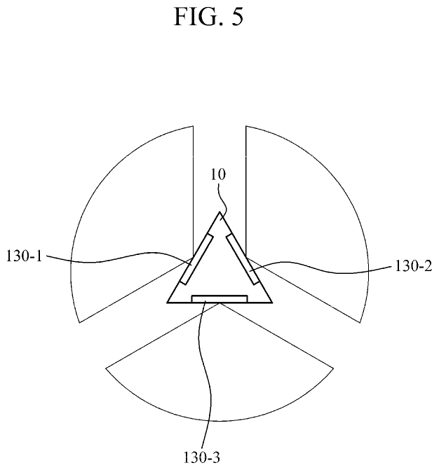

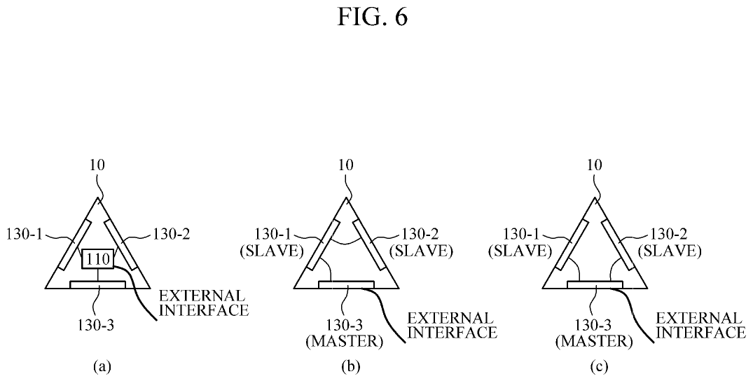

FIG. 5 illustrates a concept of an integrated radar device in which three radar modules are combined according to the present invention, and FIG. 6 schematically illustrates interface connections between a control module and the radar modules of the integrated radar device of FIG. 5.

According to another embodiment of the present invention, as shown in FIG. 5, an integrated radar device 10 is equipped with three radar modules 130-1, 130-2, and 130-3 which are each disposed on one side surface of a housing having a triangular shape, thereby expanding an FOV.

FIG. 6A illustrates a configuration in which a control module 110 is provided as a separate PCB, and the control module 110 is connected directly to each radar module 130 (star type interface). FIGS. 6B and 6C illustrate examples in which the control module 110 is not provided as a separate PCB and is mounted on a master radar module 130-3. FIG. 6B illustrates that slave radar modules 130-1 and 130-2 are connected in a chain type (chain type interface), and FIG. 6C illustrates that the slave radar modules 130-1 and 130-2 are connected directly to the master radar module 130-3 (star type interface).

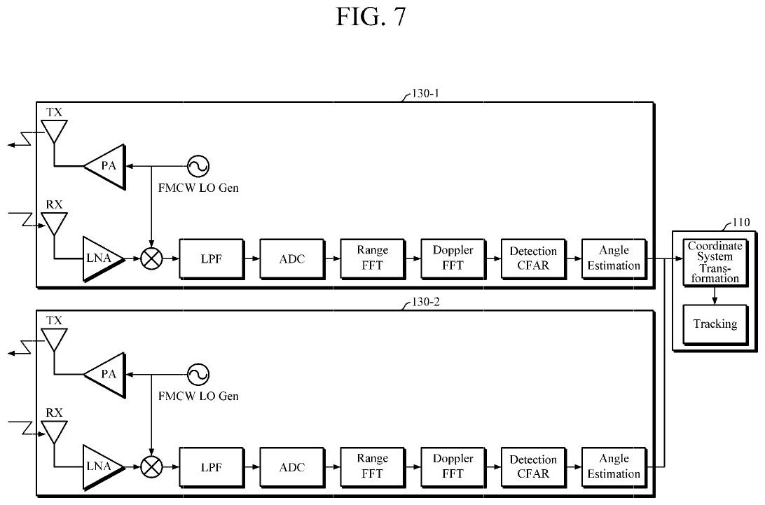

FIG. 7 schematically illustrates an example of an integrated radar device to which a frequency modulated continuous wave (FMCW) radar module is applied according to the present invention. According to another embodiment of the present invention, a radar of a plurality of radar modules 130 may be an FMCW type radar.

The FMCW type radar is a type of radar which may modulate a frequency of a continuously transmitted signal according to a time and may extract velocity information as well as distance information through a modulated amount of a received frequency.

As shown in the block diagram of the FMCW radar of FIG. 7, the radar module 130 includes a transmitting antenna, an FMCW local oscillator generator, a power amplifier (PA), a receiving antenna, a low noise amplifier (LNA), a mixer, an analog-to-digital converter (ADC), a range FFT for calculating distance information, a Doppler FFT for calculating velocity information, a constant false alarm rate (CFAR) detector, and an angle estimation unit.

According to the present invention, a plurality of radar modules can be integrated into one device, and an FOV of the radar device can be expanded using the plurality of radar modules disposed to form a predetermined angle.

Although the present invention has been described above using embodiments with reference to the accompanying drawings, the present invention is not limited thereto. The present invention should be interpreted as including various modified embodiments that may be evidently derived from the above embodiments by one of ordinary skill in the art. The claims below are intended to include such modified embodiments.

1. An integrated radar device comprising:
a plurality of radar modules disposed such that radiated radar signals are directed in different directions; and
a control module including a coordinate system transformation unit which receives position outputs of a detected target expressed in a local coordinate system by the individual radar modules and transforms the received position outputs to a global coordinate system, and an integrated tracking unit which tracks the target by integrating the position outputs of the individual radar modules transformed to the global coordinate system.

2. The integrated radar device of claim 1, wherein the plurality of radar modules include:
a master module including the control module; and
a slave module connected directly to the master module or connected to the master module through another radar module.

3. The integrated radar device of claim 1, wherein the plurality of radar modules are frequency modulated continuous wave (FMCW) type radars.

4. The integrated radar device of claim 1, wherein the control module further includes a calibration unit which calibrates the coordinate system transformation unit according to an angle formed between the individual radar module and the radar module adjacent thereto.

5. The integrated radar device of claim 2, wherein the plurality of radar modules are frequency modulated continuous wave (FMCW) type radars.

6. The integrated radar device of claim 2, wherein the control module further includes a calibration unit which calibrates the coordinate system transformation unit according to an angle formed between the individual radar module and the radar module adjacent thereto.
